(19) United States
(12) Patent Application Publication
(10) Pub. No.: US 2009/0096873 A1
(43) Pub. Date: Apr. 16, 2009

(54) Method and System for Processing an Image for Testing a Cdd/Cmos Sensor

(75) Inventors: Jacques Hennes, Verrieres Le Buisson (FR); Jean-Claude Leclercq, Paris (FR); Laurent Dufrechou, Saint-Andre De L'Eure (FR)

Correspondence Address: FOLEY AND LARDNER LLP;SUITE 500, 3000 K STREET NW, WASHINGTON, DC, 20007, US

(73) Assignee: ATELIER INFORMATIQUE ET ELECTRONIQUE

(21) Appl. No.: 11/992,294

(22) PCT Filed: Sep. 21, 2006
(86) PCT No.: PCT/EP2006/066598

§ 371 Date: May 21, 2008

(30) Foreign Application Priority Data
Sep. 23, 2005 (FR) 0509757

(51) Int. Cl. H04N 17/00

(52) U.S. Cl. 348/187

(57) ABSTRACT

According to a first aspect, the invention concerns an image sensor test system (1) that performs processing on an image (I₁-I₃) supplied by the sensor (1), during which the same operation is performed for each pixel of the image, characterised in that it includes a plurality of processing modules (MT₁-MT₄), where each module has:
a memory that includes an Image zone (I) in which the image is intended to be stored;
a processor (P₁-P₄) connected to the memory and capable of executing the said operation on a group of pixels of the image stored in the Image zone (I).

The invention also concerns a process for testing an image sensor (1) that performs processing on an image (I₁-I₃) supplied by the said sensor, during which the same operation is performed for each pixel of the image, characterised in that it includes stages which:
store the said image (I₁-I₃) in a plurality of processing modules (MT₁-MT₃);
and, in each of the processing modules, execute the said operation on a group of pixels (a, b, c, d) of the said image.

The area of the invention is that of processing a digital image during which the same operation is performed for each pixel of the image.

The invention more precisely concerns the processing of digital images for the purpose of testing the CCD or CMOS sensor that was used to acquire the images, and aims to propose a system and a process to accelerate such a process, and therefore the testing of image sensors.

We recall that a monochrome image is composed of pixels, with each pixel carrying intensity information. Colour, for its part, is created by making the pixels sensitive to the fundamental colours by means of a filter. For example, the use of a Bayer filter provides pixels that are alternately green, red, green, blue, green, red, green, blue, etc.

An image sensor is a device which allows the transformation of an image, described by its luminous intensity and its colour in each pixel, into an electrical signal, typically usable to perform processing of the image, its transmission, its storage, or its display on different viewing media.

A photosensitive device, in general a photodiode or a photoMOS, is thus used to convert the stream of photons received at a pixel, into a stream of electrons. This stream of electrons is then accumulated during the period of exposure, in a capacitor connected to the pixel.

At the end of the exposure period, the voltage, and therefore the charge, at the terminal of this capacitor is transmitted directly out of the sensor in the form of a voltage (in the case of a CCD sensor—a charge coupled device) or converted into a binary code by a analogue/digital converter and then transmitted in the form of a digital signal (in the case of a CMOS sensor).

Acquisition of the pixels which constitute an image is effected in a sequential manner by means of an electronic acquisition card forming the interface between the CMOS or CCD sensor to be tested and a memory intended to store the image.

The test of each sensor consists of analysing the image supplied by the sensor, on a pixel by pixel basis. The aim of this analysis is to detect the defective parts and to carry out the necessary adjustments (focussing, calibration, etc.).

The intensity of each pixel can be represented by a digital magnitude encoded in different formats such as unsigned integer, signed integer or signed floating point. Since each pixel is represented by a digital value, an image is therefore represented by a table of values.

The analysis of the image therefore consists of performing a processing operation on a table, (typically a combination of elementary operations) the result of which is used to certify the correct operation of the sensor.

With the exception of the fast Fourier transform, image processing consists of carrying out the same combination of elementary operations on each pixel.

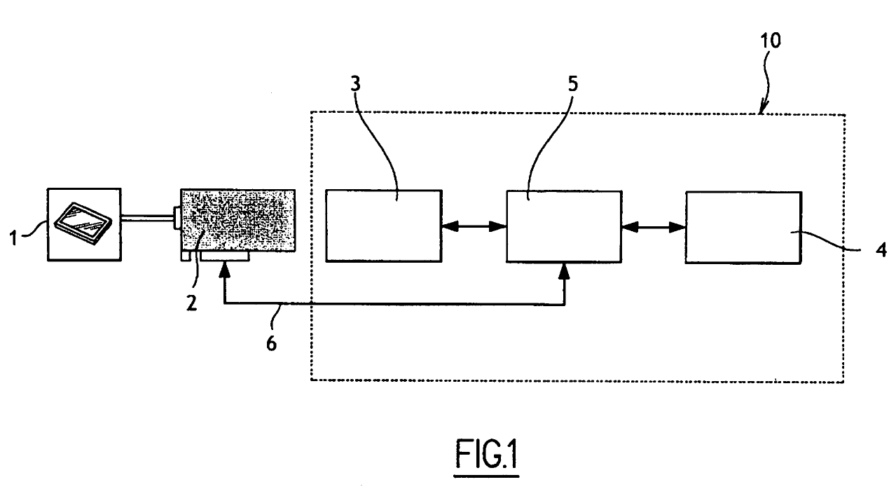

FIG. 1 shows a digital image processing system 10 intended to be used to test the sensor 1 that was used for acquisition of the images. The system 10 includes a processor 3, a memory 4 and a memory access controller 5 interfaced between the processor 3 and the memory 4.

As already mentioned above, the test consists of performing the same operation for each of the pixels making up an image acquired by means of the sensor 1.

An electronic acquisition card 2 is typically used for making the connection between the sensor 1 and the system 10. More precisely, the card 2 is connected to the system 10 by means of a system bus 6.

By means of the bus 6, the card 2 transfers to the memory 4 of the system 10 one or more images in the form of a table of values.

Processing of the image is then effected by the processor 3 of the system 10. However, this processing can turn out to be relatively long. Its speed is actually limited in particular by the processing speed of the arithmetic and logic unit ALU of the processor 3, and by the speed of the bus connecting the memory 4 to the processor 3.

Testing of an CMOS/CCD image sensor is thus a lengthy operation, and the time devoted to testing comes at a high cost, which can represent up to 30% of the total production cost of a sensor. There is therefore a need for a technique that allows the production cost of a CCD or CMOS sensor to be reduced by reducing the time devoted to testing the sensor.

It will be noted that a proposal has been made to use a multi-processor system in order to accelerate the processing of information by dividing this processing between different parallel processors. But the various processors of such a card share the same memory. The processors are then in competition to access the stored data, and the memory access passband then constitutes a bottleneck in such systems, limiting the processing speed. It can therefore be seen that such systems are not totally satisfactory.

The invention has as its objective to meet the aforementioned need for a rapid test for a CMOS/CCD image sensor. To this end, the invention proposes, according to a first aspect, an image sensor test system that performs processing on an image supplied by the sensor, during which the same operation is performed for each pixel of the image, characterised in that it includes a plurality of processing modules, where each module has:
a memory that includes an Image zone in which the image is intended to be stored;
a processor connected to the memory and capable of executing the said operation on a group of pixels in the image stored in the Image zone.

Certain preferred but not limiting aspects of this system are as follows:
the memory of each processing module also includes a Command zone used to indicate to the processor of the said module the group of pixels for which it must execute the operation;
the processors are each commanded to execute the operation on a different pixel group of the image;
the memory of each processing module also includes a Program zone, in which the operation is stored in the form of instructions that are executable by the processor of the module;
the memory of each processing module also includes a State zone in which is stored a state relating to the execution of the operation by the processor of the module;
the system also includes an acquisition card connected to the Image zone of each of the processing modules by means of an image bus, so as to perform the simultaneous storage of the image in the Image zone of each of the processing modules;
the system also includes a central unit connected to the acquisition card by means of a system bus, with the acquisition card being connected to each module by means of a local bus, so that the central unit is able, by means of the system bus and each local bus, to command the processor of each processing module so that it executes the said operation, and is in possession of the result of executing the operation by the processor of each module;
the sensor of the system is a CCD or CMOS sensor.

According to a second aspect, the invention proposes a process for testing an image sensor that performs processing of an image supplied by the said sensor, during which the same operation is performed for each pixel of the image, characterised in that it includes stages for:
storing the said image in a multiplicity of processing modules;
and, in each of the processing modules, executing the said operation on a group of pixels of the said image.

Certain preferred but not limiting aspects of this process are as follows:
the storage stage is effected simultaneously for each processing module;
the execution stage is effected simultaneously in each module;
the process includes a stage for passing on to each processing module a parameter relating to the group of pixels to be subjected to the said operation;
the process includes a transmission stage during which each module transmits, to a central unit, a state relating to the implementation of the execution stage;
each module then transfers the result of the said execution stage to the central unit.

Other aspects, aims and advantages of this present invention will appear more clearly on reading the following detailed description of preferred forms of implementation of the latter, given by way of a non-limiting example, and with reference to the appended drawings in which, in addition to FIG. 1 mentioned previously:

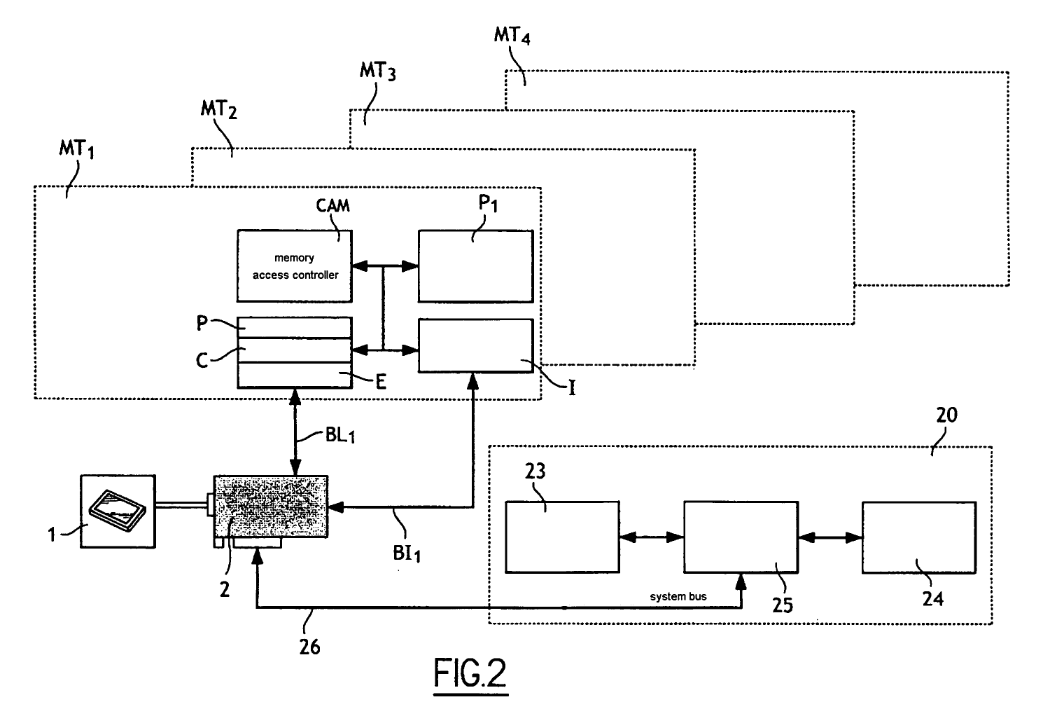

FIG. 2 is a diagram of a system according to one possible embodiment of the first aspect of the invention;

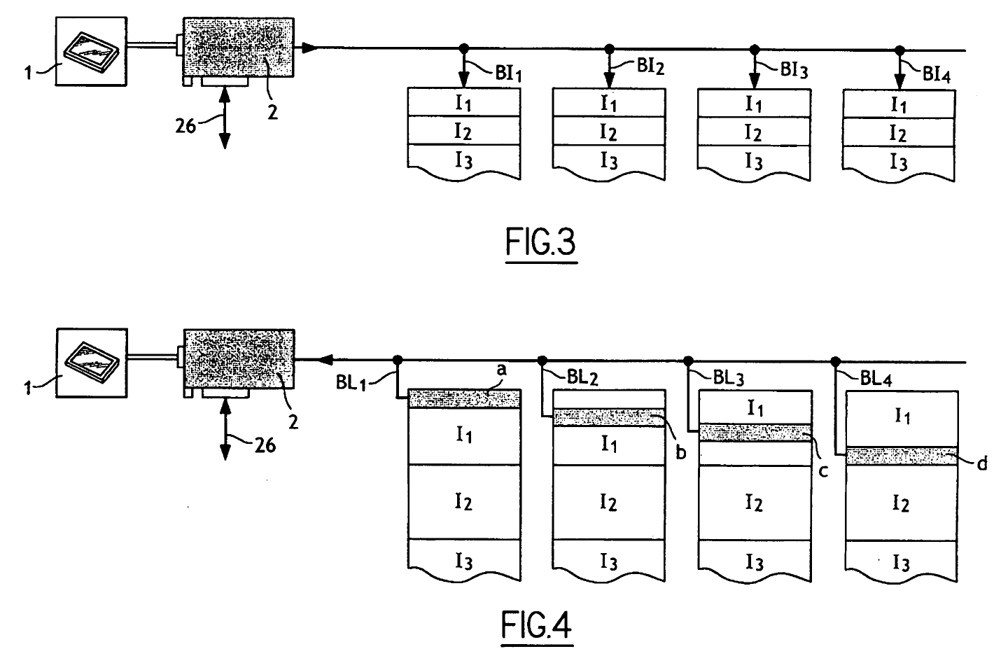

FIG. 3 schematically represents the loading of the images to be processed into the memory of each of the processing modules;

FIG. 4 schematically represents the processing of an image by the different processing modules.

In general, the invention proposes to accelerate the processing of images coming from CMOS or CCD images by increasing the number of processors used, and by proportionately increasing the data speed between the processors and the memory that contains the images.

As already mentioned above, the processing is intended to allow the testing of a CCD or CMOS sensor, and consists of performing the same operation (the same combination of elementary operations) on each pixel of an image acquired by means of the sensor.

In order to accelerate the processing, the invention proposes that each processor should perform this combination of elementary operations on part of the image. The processing speed will then be multiplied by the number of processors.

In addition, in order not to be limited by the access passband to the memory, the invention advantageously provides that each processor has its own memory.

FIG. 2 shows one possible embodiment of a system for processing a digital image in accordance with the first aspect of the invention.

As for the system of previous design illustrated in FIG. 1, the processing system according to the invention is connected to an acquisition card 2 used to acquire the images coming from a sensor 1 to be tested (typically a CCD or CMOS sensor).

The system includes a central unit 20 as well as a multiplicity of processing modules MT₁-MT₄.

The central unit 20 has an architecture similar to that of the system 10 of FIG. 1. The unit 20 thus includes a processor 23, a memory 24, and a memory access controller 25 allowing exchanges of data between the processor 23 and the memory 24. The unit 20 is connected to the acquisition card 2 by means of a system bus 26. It will be noted however that in contrast to the system 10 of previous design shown in FIG. 1, the processor 23 of the system in accordance with the invention is not responsible for performing the processing of an image, and the memory 24 is not intended to store the images to be processed.

In FIG. 2, for reasons of clarity, only the components of the MT1 module are shown, but it will be understood that the processing modules all have the same architecture.

Each processing module MT₁-MT₄ indeed includes:
a processor P₁-P₄;
a memory connected to the processor by means of a memory access controller (MAC) which includes:
an Image zone I in which an image used for the test is intended to be stored;
a Program zone P in which the test operation (combination of elementary operations) is stored in the form of instructions that are executable by the processor;
a Command zone C intended for the passing of commands between the central unit 20 and the processor P₁-P₄;
a State zone E intended for the passing of states between the processor P₁-P₄ and the central unit 20.

It is specified here that the elementary operations can be grouped in the form of a library in the Program zone P. These operations are identical for each processing module, so that each processor executes the same operations.

Preferably, the Image zone I of each processing module MT₁-MT₄ is directly connected to the acquisition card 2 by means of an image bus BI₁.

It is therefore possible to simultaneously load the image or images to be processed (in the form of tables of values corresponding to the pixels of the image to be processed), by means of each image bus BI₁-BI₄, for the storage of the processing modules MT₁-MT₄ in each of the Image zones I. The stored image or images are thus identical for each processing module.

In addition, a local bus BL₁-BL₄ is used to connect the Command C and State E memory zones of each of the modules MT₁-MT₄ to the acquisition card 2, and from there to the central unit 20 by means of the system bus 26.

Each processor is commanded to execute the same image processing function (execution of the processing operation, meaning the combination of elementary operations) on a group of pixels of the image, that is on a fraction of the image.

To this end, each processor executes the operation loaded in executable form in the Program zone P of the associated with it.

The execution of a given function on different image fractions assumes the passing of parameters by the processor 23 of the central unit 20, and in particular of parameters used to address the image zone to be processed.

These parameters are transmitted, during a passing stage, to each processing module MT₁-MT₄ by means of a local bus BL₁-BL₄ for storage in the Command zone C associated with the processor P₁-P₄ of each processing module.

These parameters are used in particular to indicate to the processor that this is the zone of the image that it must process.

When each processor has executed the operation on the image zone assigned to it, processing is ended, and the processor indicates this to the central unit 20 by the transmission of a state. The state is then recorded by the processor in the State zone E of the memory, and then transmitted to the acquisition card 2 by means of the local bus, with the card 2 then indicating the said state to the central unit 20 by means of the system bus 26.

The processed image or the results of the processing are then transferred to the processor of the central unit by means of the system bus.

FIG. 3 schematically shows the loading, by means of the image bus BI₁-BI₄, from the acquisition card 2 to the different processing modules MT₁-MT₄, of the images to be processed I₁-I₃ in order to perform the test of the sensor 1. The images I₁-I₃ are then simultaneously stored in the Image zone I of the memory of each of the processing modules MT₁-MT₄.

In other words, the same image data is sent simultaneously to each processing module, which can be effected in a relatively short execution time. In particular, such an operation does not require performing a sort in the stream of images coming from the tested sensor 1.

The processors P₁-P₄ of the processing modules MT₁-MT₄ then simultaneously execute the operation (loaded in each Program zone P of the processing modules) of processing the images I₁-I₃ stored in each Image zone I of the processing modules.

To this end, each processor is commanded by the central unit 20, with the Command zone C of the memory allowing passage of the commands via the local bus. In particular, the Command zone C is used to pass, to the processor, a parameter to indicate to it the group of pixels of the image that it must process.

In addition, it can be seen that by equipping each processor with its own memory, the processing speed of the image or images is maximised.

FIG. 4 schematically illustrates the processing of an image I1 by the different processing modules MT₁-MT₄.

The processors P₁-P₄ are each commanded to execute the processing operation (loaded in the Program zone P of the memory associated with them) on a different pixel group of the image I1, meaning a different fraction of the image.

As shown in FIG. 4, processor P₁ executes the processing operation on fraction (pixel group) a of image I1, processor P₂ on fraction b, processor P₃ on fraction c of image I1, and processor P₄ on fraction d.

Advantageously of course, the union of fractions a, b, c and d represents the whole of image I₁, and the simultaneous processing of these different fractions a, b, c, d of image I₁ by the different modules therefore enables this image to be processed in its entirety.

When the processing of a fraction of the image has been effected by a processor P₁-P₄, the latter transmits a state, indicating completion of the processing, by means of the local bus BL₁-BL₄ to the card 2, which is then responsible for indicating this state to the central unit 20 by means of the system bus 26. The processed image, or the results of the processing, are then transferred to the processor 23 of the central unit 20 by means of the system bus 26.

1. An image sensor test system that performs processing on an image supplied by the sensor, during which the same operation is performed for each pixel of the image, the system comprising a plurality of processing modules, where each module comprises:
a memory that includes an Image zone in which the image is intended to be stored;
a processor connected to the memory and capable of executing the said operation on a group of pixels of the image stored in the Image zone.

2. A system according to claim 1, wherein the memory of each processing module also includes a Command zone used to indicate to the processor of the said module the group of pixels on which it must execute the said operation.

3. A system according to claim 1, wherein the processors are each commanded to execute the said operation on a different pixel group of the image.

4. A system according to claim 1, wherein the memory of each processing module also includes a Program zone in which the said operation is stored in the form of instructions that are executable by the processor of the said module.

5. A system according to claim 1, wherein the memory of each processing module also includes a State zone in which is stored a state relating to the execution of the operation by the processor of the said module.

6. A system according claim 1, further comprising an acquisition card connected to the Image zone of each of the processing modules by means of an image bus, so as to perform the simultaneous storage of the image in the Image zone of each of the processing modules.

7. A system according to claim 1, further comprising a central unit connected to the acquisition card by means of a system bus, with the acquisition card being connected to each module by means of a local bus so that the central unit is able, by means of the system bus and of each local bus, to command the processor of each processing module so that it executes the said operation, and is in possession of the result of execution of the operation by the processor of each module.

8. A system according to claim 1, wherein the sensor is a CCD or CMOS sensor.

9. A process for testing an image sensor, that performs processing on an image supplied by the said sensor, during which the same operation is performed for each pixel of the image, the process comprising stages that:
store the said image in a plurality of processing modules;
and, in each of the processing modules, execute the said operation on a group of pixels of the said image.

10. The process according to claim 9, wherein the storage stage is effected simultaneously for each processing module.

11. The process according to claim 9, wherein the execution stage is effected simultaneously with each module.

12. The according to claim 9, further comprising a stage for passage to each processing module of a parameter relating to the group of pixels to be subjected to the said operation.

13. The process according to claim 9, further comprising a transmission stage during which each module transmits, to a central unit, a state relating to the implementation of the execution stage.

14. The process according to claim 13, wherein each module then transfers the result of the said execution stage to the central unit.
